(19) United States
(12) Patent Application Publication
(10) Pub. No.: US 2025/0013681 A1
(43) Pub. Date: Jan. 9, 2025

(54) APPARATUS FOR DETECTING AND HANDLING ANOMALOUS BEHAVIOR BY USERS AND OTHER ENTITIES

(71) Applicant: Charles Schwab & Co., Inc., San Francisco, CA (US)

(72) Inventors: Barrington YOUNG, San Francisco, CA (US); Charles E. GOTLIEB, San Francisco, CA (US)

(73) Assignee: Charles Schwab & Co., Inc., San Francisco, CA (US)

(21) Appl. No.: 18/891,323

(22) Filed: Sep. 20, 2024

Related U.S. Application Data
(63) Continuation of application No. 16/237,402, filed on Dec. 31, 2018.
(60) Provisional application No. 62/612,597, filed on Dec. 31, 2017.

(51) Int. Cl. G06F 16/335; G06F 17/18; G06F 21/55; G06Q 40/12

(52) U.S. Cl. CPC G06F 16/335; G06F 17/18; G06F 21/552; G06F 21/554; G06Q 40/123

(57) ABSTRACT

A system and method collects activity data from one or more data sources recording activities of users and other entities and identifies anomalous activity using a statistical analysis of behaviors that are defined using one or more activities, optionally performed in a sequence, optionally performed within a limited time period, and optionally meeting or being excluded from, a filter. The analysis may incorporate the use of a normal, and any number of special, periods, where the analysis uses data from prior periods of the same type.

### RELATED APPLICATION

This application is a continuation of U.S. patent application Ser. No. 16/237,402, filed Dec. 31, 2018, which claims the benefit of U.S. Provisional Patent Application No. 62/612,597, filed on Dec. 31, 2017, each of which is hereby incorporated by reference in its entirety.

### FIELD OF THE INVENTION

The present invention is related to computer software and hardware and more specifically to computer software and hardware for anomalous behavior detection and handling.

### BACKGROUND OF THE INVENTION

Computer systems currently do not provide detection of anomalous user and other entity behavior with sufficient granularity to identify the cause of a potential problem. One way of providing such functionality is to use screen sharing over a network connection, whereby a security professional can watch what any user is doing by surreptitiously sharing the screen of different users at random times using software installed on the personal computer system the user uses to interact with secure data. The security professional can see what the user is doing with sufficient granularity to determine if the anomalous behavior is a problem or not. However, such screen sharing is both processor and network intensive, making the computer system of the users less efficient than they would be if no screen sharing were employed.

What is needed is a system and method that can both detect anomalous user and other entity behavior and identify the source of the potential problem that doesn't impact the network and computing resources of the user's personal computer system.

### SUMMARY OF INVENTION

A system and method receives definitions of data sources that record activities of users and/or computer programs as the user interacts with securely stored data, the identifiers of certain individuals and other targets (e.g. computer programs) to monitor, definitions of behaviors to monitor (each of which may be a single activity, multiple activities, and may specify a sequence of multiple activities, a time period in which all of the multiple activities must be performed, and filtering criteria to only include or exclude certain activities), definitions of time periods and special time periods (e.g. end of month) and other time parameters, including length of a period (e.g. 15 minutes), definitions of models for computing a score from the number times a monitored behavior was performed by a user in the most recent period, and definitions of formulas for combining multiple scores from monitored behavior into other scores. The models may be different based on the independence of the activities in a monitored behavior, which is tested for each behavior or behavior type and time period.

The system and method then collects such activity data and scores it according to the definitions described above for each user or other monitored target, considering certain monitored targets to be the same target, for example, if the monitored targets are all different instances of the same program. The system and method combines the scores and compares the combined one or more scores to one or more thresholds and alerts a system administrator to behavior considered anomalous, as measured by statistics of preceding periods of the same type (e.g. end of month). The administrator can review the components of the score that triggered the alert at varying levels of granularity, and may disable privileges for a user or other monitored target if the anomalous behavior indicates a potential problem.

### BRIEF DESCRIPTION OF THE DRAWINGS

FIG. 1 is a block schematic diagram of a conventional computer system.

FIG. 2 is a block schematic diagram of a method of detecting and handling anomalous behavior of a user or other target according to one embodiment of the present invention.

FIG. 2A is a first flow chart of the method of FIG. 2 according to one embodiment of the present invention.

FIG. 2B is a second flow chart of the method of FIG. 2 according to one embodiment of the present invention.

FIG. 2C is a third flow chart of the method of FIG. 2 according to one embodiment of the present invention.

FIG. 3 is a block schematic diagram of a system for detecting and handling anomalous behavior of a user or other target according to one embodiment of the present invention.

### DETAILED DESCRIPTION OF A PREFERRED EMBODIMENT

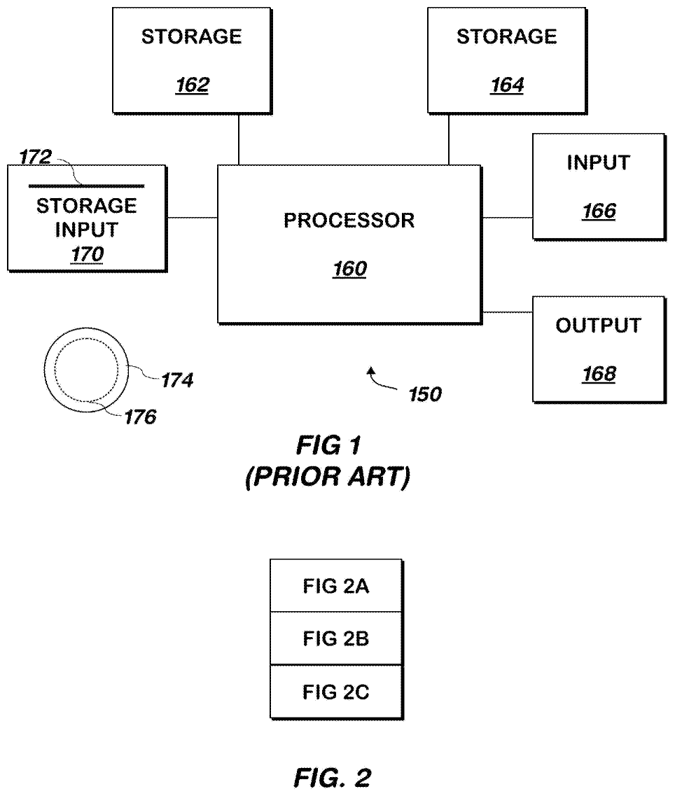

The present invention may be implemented as computer software running on a conventional computer system, computer software embodied on a non-transitory storage media, dedicated circuitry, or otherwise. Referring now to FIG. 1, a conventional computer system 150 for practicing the present invention is shown. Processor 160 retrieves and executes software instructions stored in storage 162 such as memory, which may be Random Access Memory (RAM) and may control other components to perform the present invention. Storage 162 may be used to store program instructions or data or both. Storage 164, such as a computer disk drive or other nonvolatile (i.e. non-transitory) storage, may provide storage of data or program instructions. In one embodiment, storage 164 provides longer term storage of instructions and data, with storage 162 providing storage for data or instructions that may only be required for a shorter time than that of storage 164. All storage elements described herein may include conventional memory and/or disk storage and may include a conventional database. Other system elements may include a conventional processor that performs the functions described. All elements of a system include any or all of at least one input, at least one output and at least one input/output.

Input device 166 such as a computer keyboard or mouse or both allows user input to the system 150. Output 168, such as a display or printer, allows the system to provide information such as instructions, data or other information to the user of the system 150. Storage input device 170 such as a conventional floppy disk drive or CD-ROM drive accepts via input 172 computer program products 174 such as a conventional floppy disk or CD-ROM or other nonvolatile storage media that may be used to transport computer instructions or data to the system 150. Computer program product 174 has encoded thereon computer readable program code devices 176, such as magnetic charges in the case of a floppy disk or optical encodings in the case of a CD-ROM which are encoded as program instructions, data or both to configure the computer system 150 to operate as described below.

In one embodiment, each computer system 150 is a conventional SUN MICROSYSTEMS T SERIES SERVER running the ORACLE SOLARIS 11 or higher operating system commercially available from ORACLE CORPORATION of Redwood Shores, California, a PENTIUM-compatible personal computer system such as are available from DELL COMPUTER CORPORATION of Round Rock, Texas running a version of the WINDOWS operating system (such as 7, 8 or 10) commercially available from MICROSOFT Corporation of Redmond Washington or a Macintosh computer system running the OS X operating system commercially available from APPLE INCORPORATED of Cupertino, California and the FIREFOX browser commercially available from MOZILLA FOUNDATION of Mountain View, California or INTERNET EXPLORER browser commercially available from MICROSOFT above, although other systems may be used. Each computer system 150 may be a SAMSUNG GALAXY S9 commercially available from SAMSUNG ELECTRONICS GLOBAL of Seoul, South Korea running the ANDROID operating system commercially available from GOOGLE, INC. of Mountain View, California. Various computer systems may be employed, with the various computer systems communicating with one another via the Internet, a conventional cellular telephone.

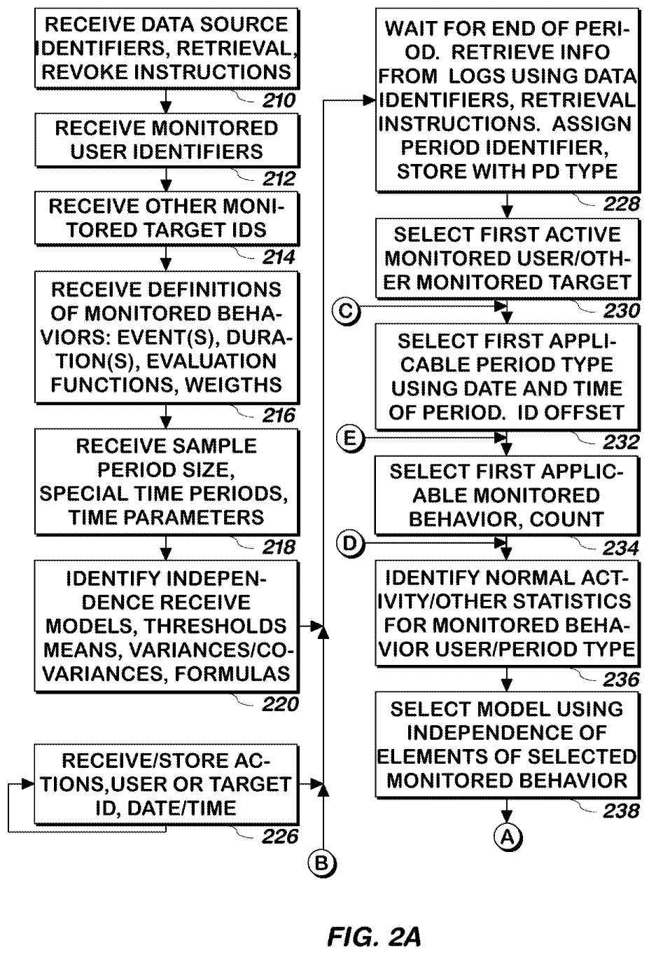

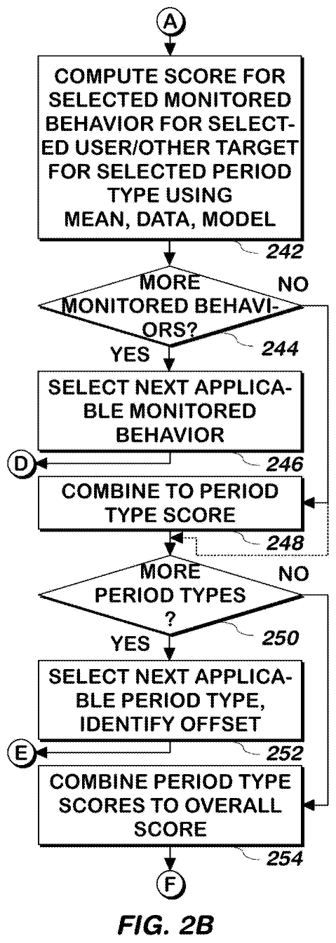

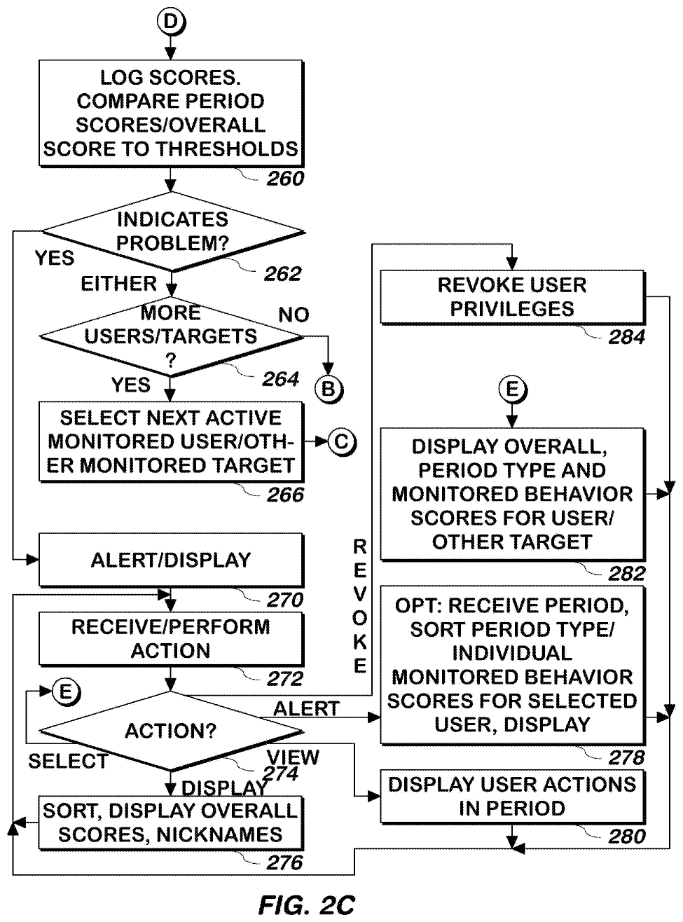

Referring now to FIG. 2, consisting of FIG. 2A, FIG. 2B and FIG. 2C, a method of identifying anomalies in user and other target behavior and handling them is shown according to one embodiment of the present invention.

Data sources of user behavior and that of other targets to be monitored are identified 210. Monitored user and other target behavior data sources may include one or more databases, certain tables (or another type of portion) from one or more databases, a program, or any other destination device, data, or other entity to be monitored. Such data sources operate and store data securely, using secure protocols, such as user access security and/or encryption of the data. Retrieval instructions from the source of the monitored user and other target behavior data are also received as part of step 210. Retrieval instructions may include locations and process instructions for retrieving data from logs or other monitored user and other target behavior data sources that describe changes made to data, including what change was made, by what user or other target, and when. A name of the data source and retrieval instructions for retrieving data change information from that data source are received for each of several data sources in this step. In one embodiment, step 210 also includes instructions regarding revoking a user's privileges at each system that generates activity data in the data sources.

User identifiers of monitored users to monitor are received 212. User identifiers of users may include a nickname for the user to be used for the system and method, multiple user identifiers of the same user at multiple monitored user and other target behavior data sources, in which case the user identifiers of the user and a monitored user and other target behavior data source identifier corresponding to the user identifier, are considered to be a user identifier. The monitored data source user identifiers are those used by any of those whose identifiers are received in step 210.

Other monitored target identifiers are received 214. Other monitored targets may include computer programs that interact with other computer programs or that interact with databases that report via monitored user and other target behavior data sources. In one embodiment, a monitored program may exist in multiple instances. In such embodiment, the instances of the program are linked as part of step 214 to allow some or all of the instances of the same program to be treated by the present invention as a single entity. For example, if the instances of a computer program use any source IP address in a range of potential IP addresses and/or source ports for that program, the range of IP addresses and/or ports may be used as the target identifier of the target that is made up of the instances. In another embodiment, the identifiers are received individually in a manner that indicates which identifiers represent instances of a same monitored target that report such behaviors as monitored user and other target behavior data that should be treated as a single target. A nickname for each other monitored target may also be received. Instances of the same monitored target may be assigned the same nickname to identify them as instances that should be treated as one target. All data received or produced as described herein is stored.

Definitions of monitored behaviors are received 216. Monitored behaviors include one or more activities performed on a specified portion of the computer programs that report behaviors via the monitored user and other target behavior data sources, or ordered sequences of more than one such activity and one or more durations in which part or all of the sequence must be fully performed to be considered a sequence (the duration being greater than zero and as long as infinity), and an evaluation function to use as a filter, with activities or other inputs or outputs that don't meet the evaluation function being excluded from the monitored behavior, or required to be included as monitored behavior. For example, one definition of a monitored behavior may be defined as a first activity on one database table, a second activity on a second database table and a third activity on the second database table, all being performed by the same monitored user within 5 minutes of each other, with the first and second activities being performed within two minutes of each other, with an input amount greater than $5000 in the first activity and a result of false in the second activity. Some of these items (the event, sequence, duration(s) and evaluation function(s)) may be omitted for each monitored behavior definition and different ones of these items may be omitted for different monitored behavior definitions.

In one embodiment, steps 210 or 216 may include retrieving from the monitored user and other target behavior data sources, and storing, historical data of activities all users or of the users defined as described herein, for use as described herein.

A sample period size, definitions of one or more special time periods and other time parameters described herein are received 218. The sample period is the period of time (such as 15 minutes) between the start of sampling of the monitored behavior data. Special time periods are those that are to be treated specially as described in more detail below, and may include one or more periods around month end, month start, quarter end or start, year-end or start, holidays, special events such as tax filing days, and the like. The start and end of each special period is identified or described. Special periods may overlap, such as the end of the month, quarter and year, so that more than one may be applicable at any given time. Unique identifiers are assigned to each special period.

The joint variability of the data in each monitored behavior that includes more than one data element (e.g. a row in a table in a database) is identified 220 using the most recent historical data, retrieved as described herein, and any conventional technique, such as ANCOVA, and a determination is made as to whether any of the data elements in a behavior are jointly variable or independently variable, for each potential combination of two or more data elements in each monitored behavior.

Behaviors with only one data element are considered to be independently variable. The data elements in each monitored behavior are each marked with identifiers of any jointly variable other data element in the behavior, or, in one embodiment, each monitored behavior is either marked as jointly variable or independent, with the monitored behavior being marked as jointly variable if any two or more data elements are jointly variable, and independent otherwise. A data element is a component of monitored behavior that is independently reported by a monitored user and other target behavior data source. Models and thresholds for calculating variance and covariance of a monitored behavior are received as part of step 220. In one embodiment, the models are

$$\text{?} = \frac{\text{?}}{\text{?}} exp ( - \frac{\text{?}}{\text{?}} ) \qquad Eq . 1$$

$$\text{?} \text{indicates text missing or illegible when filed}$$

If the activities in a monitored behavior are independent

$$P ( \text{?} \sum ) = \frac{\text{?}}{( \text{?} ) \text{?}} exp ( - \frac{1}{2} ( \text{?} ) \text{?} ( X - \text{?} ) ) \qquad Eq . 2$$

$$\text{?} \text{indicates text missing or illegible when filed}$$

if the activities in a monitored behavior are jointly variable. In Eq. 1, p is the normal behavior or mean for activity i, o²i is the variance for activity i and Xi is the number of times the activity i is observed for the period. In Eq. 2, p is the normal behavior or mean for the behavior, S is the covariance, and X is the number of times the behavior is observed for the period. Any number of other conventional models may be used in other embodiments.

Thresholds may be identified for each monitored behavior and/or for all monitored behaviors performed by a particular user or other target in a particular period type, or for all monitored behaviors in a particular period type, again using recent data, or simulated bad actor data or both. Thresholds are identified to generate a target false positive rate and confidence rate that identifies bad actors with a certain degree of confidence, as part of step 220. A bad actor is a user or other monitored target doing something it shouldn't ordinarily be doing, or not doing something it should be doing that is outside an acceptable range of activities.

Means and variances or covariances may be identified for each user or other target for each behavior in each period type as well, as part of step 220 or they may be identified each time the score is calculated as described below.

Each of steps 210-220 may be performed to update and modify the data received as described above at any time.

### Monitor User Activities.

On an ongoing basis, identifiers of activities including those used in the descriptions of the monitored behaviors are retrieved and stored 226, along with the user identifier or target identifier of the entity that performed the activity and the date and time of performance of the activity. Such activities may be recorded by databases and other programs that are included in the monitored user and other target data sources as the user or other target performs activities on data such as secured data used by such data sources. Step 226 may be part of conventional activity logging performed by many conventional databases and other programs. The user identifiers and other target identifiers may include some or all of those identified in steps 210 or 212.

### Retrieve Data Describing User Activities.

At the end of the current period, which may be identified using an operating system or other timer, information from the user and other target behavior data sources about activities performed by any user or other target specified in steps 212 or 214 is retrieved from the information stored in step 226 since the end of any prior period (or the beginning of operation of the method) using the retrieval instructions, to collect and store in a database the data elements used in the monitored behaviors 228. Such collection is of data corresponding to activities that are used in the monitored behaviors without regard to whether the monitored behavior has actually occurred. For example, there may be no determination that a specified sequence has occurred before the data is retrieved and stored. A period identifier is assigned corresponding to the period in which the activities corresponding to the data sources was performed, for example, by storing the data and the time of the start of the period. Although, as described herein, the data from only the most recently ended time period is collected, historical data before that period may also be collected for use as described herein. One or more period types are assigned to the period that identifies the period as being a regular period and/or being a special period or several special periods, and an offset within the period that identifies the number of periods since the start of that type is identified using the definitions of such periods received in step 218 as described above. The start of a non-special period may be specified as a time parameter in step 218, for example by noting that the start of nonspecial periods is every Monday at midnight or every other Monday at midnight or the first Monday at midnight after the start of the month, to allow periods with similar offsets to be used as historical data. The period type may identify the special period or periods to which the data corresponds using any identifier of the special periods that apply to the most recently-ended period.

Step 228 includes retrieval of data from all data sources specified in step 210 using the retrieval instructions received in step 210.

### Select First Active Monitored User or Other Target.

A first active monitored user or other target is selected 230. An ‘active’ monitored user or other target is any user or other target for which at least one behavior was recorded in the current period. A behavior is recorded in a period if the one or more activities corresponding to the definition of that behavior have occurred (or the last one of several activities occurred in the period, with the others having occurred in the prior period) according to any sequence or time period requirements specified in that definition. In one embodiment, the instances of the same target may be treated as the same target, as specified in step 214. In one embodiment, an ‘active’ monitored user or other target is any user or target specified in steps 212 or 214, even if they have not performed any behavior, so that users or targets who have not been performing activities can be flagged if an expectation that the user or target should have been active has not been met. In one embodiment, steps 210 and 214 allow a user to be flagged as always active, in which case such users or other targets will always be selected at step 230 even if they did not perform any monitored behaviors, with users or targets not flagged not being selected if they did not perform activities in any monitored behavior in the most recent period. In one embodiment, the flag identifies the periods in which that user or other target should be active (e.g. an employee's regular work schedule), and in such embodiment, the user or other target is always selected, provided the most recent period corresponds to a period of the flag.

A first period type applicable to the period that just ended is selected 232 from those applicable to such period. In one embodiment, the normal period is always applicable and one or more other special period types may also applicable if the period most recently ended is within the definition of such special periods, and in another embodiment, each type of period has a preference and only the applicable period type with the highest preference or highest N preferences will be selected in steps 232 or 252. An offset within the period type may be identified to indicate how many periods from the start or end of the selected period type the recently ended period is. For example, if the period type is a month end, which is defined as having a start time and day (e.g. midnight 2 days before the end of the month) and end time and day (midnight, one day after the start of the next month) and the recently ended period is one period following the period beginning midnight two days before the end of the month, the offset is one period from the start of the ‘end of month’ period.

A first applicable monitored behavior is selected 234 from those defined. In one embodiment, each user or other target may be assigned a user type in steps 212 and 214 and monitored behaviors are assigned to each user types, so that applicable monitored behaviors are those assigned to the type of the user selected.

The number of times the selected user performed the selected monitored behavior that ended in the current period is counted 234 using the data retrieved in step 228, the definition of the selected monitored behavior, and the user identifiers of the selected user. All criteria of the selected monitored behavior definition is required to be met in order for a behavior to be counted. The count may include monitored behaviors that began before the start of the most recently ended period, as long as one activity of the behavior is in the most recently ended period. In one embodiment, conventional means, such as marking with a behavior identifier an activity used to count a behavior, are used to prevent an activity from being used for two different counts of the same monitored behaviors.

### Identify “Normal” Behavior for the Selected Monitored Behavior for the Selected User.

Normal behavior and other statistics (such as variance or covariance) for the selected applicable monitored behavior is identified 236 using N periods of historical data for the same type of period corresponding to the selected period for each monitored behavior for each user or other target. In one embodiment, the normal behavior is the mean number of times the selected behavior was performed by the selected user per period during the selected period type over the N periods, though other embodiments may use weighted averages, with more recent periods weighted higher than older periods. The mean may be the mean for the behavior or the mean for the activities in the behavior depending on which model was selected for the selected behavior or behavior and type of period. The variance or covariance will be identified in step 236 or at step 238 or 242, using the same data used to identify the normal behavior, based on the model selected for the selected behavior or behavior and type of period.

N may be a function of the type of period being analyzed or it may be the same for all types. For example, if N is 3 for non-special periods and the current period is not a special period, the number of historical periods to use to calculate the normal behavior is 3 periods. If N is 4 for the special tax season period of the two weeks leading up to and including tax filing day April 15^{th}, 4 periods from 4 prior tax seasons will be used.

In one embodiment, the same offset as the current one is used to retrieve historical data to calculate normal behavior. The offset may be measured from the start or end of the special period, so that the same point relative to the start or end of the period is used as historical data. Thus, if there are 86 hours and 15 minutes to the end of the special tax season period, and N is 4, a single period from each of 4 years of historical data performed by that user 86 hours and 15 minutes before the end of each of the last 4 tax seasons are used to compute normal behavior for that user. In another embodiment, the average number of per period behaviors is calculated over a larger range of periods, such as the entire normal or special period, from its start to its end, using N prior starts. So, if a normal period lasts one week, the average per period number of times the behavior is performed over 4 weeks is used as the normal behavior if N=4 and the selected period type is the normal period.

In one embodiment, the identification of normal behavior is identification of the per period average or weighted average number of times (with more recent periods weighted more heavily than less recent periods) the selected user has performed the monitored behavior in the N periods or ranges of periods (e.g. one week in the example above) identified as described above immediately preceding the most recent period. As noted, the monitored behavior may be an activity, or multiple activities or sequence of activities performed within a time period.

In one embodiment, the normal behavior is identified for as many special periods as apply to the current period (e.g. end of the month, quarter and year) as well as the normal period, instead of during the selection of each applicable period type. The actual computation need not be performed at this point in the flow, as it may be calculated one period ahead for example, or a batch may be calculated for several days, as long as the historical data to perform such calculations has all been received.

### Select Model and Compute Score

A model for the monitored behavior is selected 238 to use to score the monitored behavior. In one embodiment, the models are selected from among the two models described above. The models are selected based on whether the historical data for the monitored behavior indicates it is jointly variable or independent, though other methods of selecting models may be used. The method continues at step 242.

In one embodiment, the model to be used is selected for each combination of monitored behavior and period type, in the event that the independence of the monitored behavior varies by period type. In such embodiment, the combination of monitored behavior and period type is checked for independence and recorded in step 220 and used in step 238.

A score for the selected monitored behavior is computed 234 for the selected user or other target and for the selected applicable period type (e.g. for the current normal period or each applicable special period that applies to the current period) using the number of monitored behaviors in the most recently ended period and selected model for the selected monitored behavior using the mean (i.e. normal activity) for the monitored behavior or monitored behavior and period type. If the model uses other statistics such as variance or covariance, they are computed using historical data for the selected user and selected applicable period type. In one embodiment, the score for a monitored behavior represents the probability that the monitored behavior in the most recent period indicates that the user is performing abnormally for the user or other target, though other methods of scoring may be used.

If there are more monitored behaviors 244, the next monitored behavior, or monitored behavior applicable to the user, is selected 246 and the method continues at step 236 using the newly selected monitored behavior, and otherwise 244 the scores for the monitored behaviors of the selected period type are combined into score for the period type 248. The combination may be performed by squaring the scores, summing the squares, and then taking the square root of the sum, or other approaches so that outliers are or are not amplified. In such embodiment, the models would generate a score above 1, with the higher scores indicating a larger deviation from the norm than the lower scores. Scores may be weighted on a per behavior or per behavior-for-the-selected-period-type basis, with the weights multiplying the scores and the results summed across all behaviors. Weights may be received in step 216.

In one embodiment, individual period type scores are not computed and all scores for a user are combined into a single overall score as described below, and so step 250 follows the “no” branch of step 244, as shown by the dashed line in the Figure.

If there are more period types applicable to the most recently ended period 250, the next period type applicable to the most recently ended period is selected 252, the offset of the most recently ended period is optionally identified for the newly selected period type 252 and the method continues at step 234 using the newly selected period type and offset. If there are no more period types applicable to the most recently ended period 250, the scores for each applicable period type are combined into an overall score for the user or other target 254 and the method continues at step 260.

The scores for each period type are weighted and summed or the monitored behavior scores computed as described above are used as described above in place of the period type scores (if no period type scores are computed) to produce an overall score 254.

The weights to be used as described herein may be identified using conventional regression analysis techniques to identify fraudulent or other undesirable activities with a certain false negative and/or false positive rate, using historical data that includes some of each of known good and known bad behavior.

Although period type scores may be combined as described above, in another embodiment, the period types have a preference order, and the score for the period type with the highest preference is used, with the others being ignored. In still another embodiment, the scores are not combined and the highest period type score (or one selected on another basis) is used. The method continues at step 260 of FIG. 2B.

As described herein, the data for “the most recently ended period” is processed immediately after the period ends, however, in other embodiments, the data for such period may be processed at a later time in the same manner, by processing one period at a time, or one user at a time or using other arrangements.

The overall score and/or period type score or scores are compared to one or more thresholds 260. There may be different thresholds for different period types and a still different overall threshold may be used, identified using the same technique as the overall score, using the thresholds and any preference order or weight used to compute the overall score.

In one embodiment, for each score, there is an upper and lower threshold, for example, one standard deviation from the mean, or 20 percent above or below the mean, to identify both excess activity and insufficient activity. In another embodiment, the models drive the score in one direction for both too low activity and too high activity, so only one threshold is used.

At step 260 all scores are logged, associated with the user nickname, and the result of the comparison of step 258 is used to determine if there is a potential problem with the monitored behavior of the selected monitored user or selected other monitored target. The determination may be made because the overall score and/or any of the period type scores are above or below a threshold or outside the range of two thresholds. If the comparison indicates no problems 262, the method continues at step 270. No matter what the comparison indicates 262, if there are more users or other targets 264, the next one is selected 266 and the method continues at step 232 using the newly selected monitored user or other monitored target. If there are no more monitored users or other monitored targets 264, the method continues at step 228.

At step 270, an alert is added to a display of potential problem users and other targets, listing the nickname of the user or target and the overall score or other score. An administrator monitoring the display or desiring to monitor users may request an action and an identifier of the administrator action is received 272.

If the action is to drill down on an alert 274, which may be requested by clicking on the nickname of the user or other target corresponding to the alert, any period type scores and/or individual scores for monitored behaviors of that user in the most recent period (if the selection was made from the list of all users) or the most recent period corresponding to an alert are sorted in descending order (displayed in descending order within each of two categories of period type scores and monitored behavior scores) and displayed 278 to the administrator and the method continues at step 272.

If the action requested is to display identifiers of users to select 274, the overall score is used to sort the users and other monitored targets in descending order of the overall scores, and the overall score and nickname and other user identifiers are displayed 276 to the administrator for each monitored user and other monitored target, and the method continues at step 272. The administrator may select a different score (period type score of a specified period type or monitored behavior score of a specified behavior) to use to sort users and other monitored targets and such specified score is used to sort instead. If the action of the administrator is to select one of the nicknames displayed 274, the overall, period type and monitored behavior scores for the user are

displayed, sorted in descending order on two categories: period type or monitored behavior 282, and the method continues at step 272. If the administrator selects a monitored behavior score 274, the records of each activity that contributed to the score are displayed 280 and the method continues at step 272.

If the action of the administrator is to revoke the privileges of a user determined using the information above to be suspected of improper behavior 274, the privileges of the user are revoked at all systems from which data sources obtain activity data to prevent the user from performing some or all types of subsequent activities on such systems 284 and the method continues at step 272. The revocation instructions received in step 210 may include information on how to revoke privileges of each user on individual computer systems or on a privilege server, and such instructions are used to perform step 284. The user would then be prevented from performing at least one activity he or she could have performed otherwise. The revocation may be for the user's username on all instances of a monitored target if such information is logged, or all instances of the monitored target if it is not.

In one embodiment, revocation is performed automatically as a function of one or more of the scores and one or more thresholds, as described below.

### System.

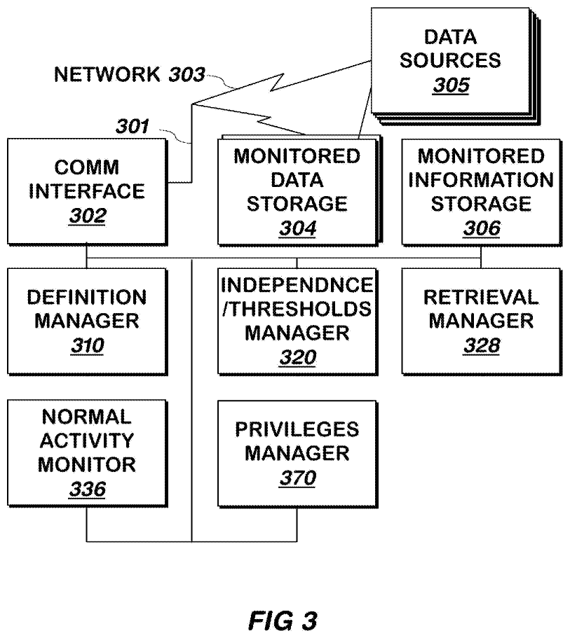

Referring now to FIG. 3, a computer-based tool for automatically detecting and handling anomalous behavior is shown according to one embodiment of the present invention.

The tool operates as a part of a computer data storage system in which sensitive data or other data for which access should be limited, is being stored. Such data is stored and accessed in monitored data storage 304, which may include SSD or other disk storage and one or more conventional databases and computer servers.

Communication interface 302 includes any conventional TCP/IP-compatible communication interface coupled to a network including an Ethernet network and the networks of the Internet via input/output 301. Unless otherwise noted, all communication to and from the elements numbered 306 and higher is made via communication interface 302. Monitored data storage 304 may be coupled to the network to which communication interface 302 is stored, and does not need to be behind that communication interface.

Definition manager 310 receives the various definitions and other information described above in steps 210-218 and stores them into monitored information storage 306, which may be computer memory or disk storage. Such information includes identifiers of data sources and retrieval and revocation instructions for such data sources, identifiers of monitored users at each data source (to each of which definition manager 310 may assign a “nickname”, a unique user identifier that is used by the other elements of the system of FIG. 3 when referencing users, identifiers of other monitored targets, optionally for each data source, definitions of monitored behaviors, sample period size or sizes, definitions of special time periods, time parameters, and other information as needed or as described above. A monitored behavior may be tied to a specific one or more data sources. Monitored behaviors may be assigned to one or more defined user types and each user may be assigned to a type, all using definition manager 310, which stores all such information received into monitored information storage 306.

When signaled by a system administrator, which may be at any of multiple times throughout the year, independence/thresholds manager 320 receives or retrieves,

and analyzes, historical data stored in monitored data storage 306 as described below using the definitions and other information stored in monitored information storage 306 to identify independence and determines the thresholds using real or simulated bad and good actor data as described above with respect to step 220 and stores an indication of dependence or independence and the thresholds for each monitored behavior into monitored information storage 306.

Models may be received as described above in step 320 by definition manager 310 or independence/threshold manager 320, either of which stores them into monitored information storage 306, or they may be programmed into the elements of FIG. 3 that use them as described in more detail below.

Data sources 305 (also referred to herein as monitored data sources) are computer programs and/or processes that access or create the monitored data in monitored data storage 304. As they operate, they also write, into logs or other data structures in monitored data storage 304, the activities of their users, including a description of the activity, an identifier of the user on that data source 305, and the date and time retrieved from a server or operating system (not shown). Data sources 305 may include database programs or other programs for which data access has a need to be controlled, and/or for which unusual patterns of access can indicate a user who is performing activities other than those related to the normal business for which data sources 305 are being used. Such data sources 305 may be referred to herein as “normalized computer programs” as a defined term, and may operate on computer systems separate from the computer system that operates elements 306-370.

Definition manager 310 receives from the system administrator as part of the information described above a retrieval period or retrieval period for each monitored data source, and sets a timer for that period in operating system (not shown). Each time the timer elapses, definition manager 310 restarts the timer for that period and signals retrieval manager 328.

When so signaled, retrieval manager 328 retrieves the activity information from monitored data storage 304 that is produced by the data sources 305 for the monitored users and other monitored targets and other information as indicated in monitored information storage 306 as described above and stores such information including an identifier of the monitored data source and user or other target identifier, as well as an identifier of the activity performed, into monitored information storage 306, along with the date and time of the activity, and an identifier of each applicable period type or types, assigned by definition manager 310 as it receives the periods corresponding to each type. The information retrieved may be over inclusive, which retrieval manager 328 may filter before or after storage. For example, activity identifiers other than those used in the monitored behaviors may be retrieved and then discarded as part of the retrieval of the activities. As noted above, retrieval of activity information from a data source 305 may be limited to the information retrieved since any prior retrieval of such activity information from that data source 305, though older information may be retrieved. In one embodiment, such older information is retrieved after the definitions have been received, such as via the signal made by definition manager 310 to retrieval manager 328 that is sent when the system administrator indicates that the definitions are initially complete, at least for the time being, and each time a new monitored behavior definition is received by definition manager 310. Retrieval manager 328 signals definition manager 310 when such historical information has initially been retrieved so that retrieval manager 328 can select the models for each behavior, by testing for independence as described above. Definition manager 310 then stores an identifier of the model associated with each behavior in monitored information storage 306 to be used when computing the scores as described above. In one embodiment, independence is retested periodically by definition manager 310 using the data retrieved for analysis of anomalous behavior as at least some of the historical data.

Retrieval manager 328 performs a retrieval of multiple periods of such activity information as historical information, and then signals independence/thresholds manager 320, which performs the activities described above, using such historical information. Additionally, the information that retrieval manager 328 retrieves may be retained to use as historical information in a later period.

Each time the information for the most recent period is retrieved, retrieval manager 328 signals normal activity monitor 336 with the location of the retrieved information in monitored information storage 306. When signaled, normal activity monitor 336 identifies the normal activity and other statistical information used by the model for each monitored behavior for each monitored user or active target and computes a score for such monitored behavior as described above with respect to steps 230-246 above using the information in monitored information storage, including activity information for the most recent period for each period type. In one embodiment, normal activity monitor 336 selects the first monitored user or active target stored in monitored information storage 306 and selects the first applicable period type using the date and time of the period stored with the most recently retrieved information, and identifies the offset as described above. The first monitored behavior or monitored behavior for that user or user type to whom the user is assigned is selected and the selected monitored behavior is counted for the user during the most recent period. The normal activity for the selected monitored behavior is identified as described above and the monitored behavior score is computed for each applicable period type as described above, all by normal activity monitor 336, and the process is repeated for each applicable monitored behavior for the selected target, the period type scores are computed by summing the monitored behavior scores for each period type, and the period type scores are combined into an overall score, all by normal activity monitor 336 and the process is repeated for each target, and the monitored behavior scores, period type scores and identifier of the period type corresponding to each score and the overall score and a unique identifier of the user are stored in monitored information storage 306 with the corresponding user identifier and a period identifier, and normal activity monitor 336 signals privileges manager 370.

When it receives such signal, privileges manager 370 compares each of the period type scores and the overall score to thresholds it receives from a system administrator, or computes as described above, and signals an alert to a system administrator if the comparison indicates that the behavior is outside the normal behavior as described above.

The system administrator uses the alert to identify whether the abnormal behavior is cause for revocation of the user's privileges, and if so, signals privileges manager 370 via a user interface element it provides. The user interface also allows the system administrator to request the actions of steps 272-282 and privileges manager 370 performs such actions using the information in monitored information storage 306 and displays the requested information as described above.

In one embodiment, privileges manager 370 or definition manager 310 receives from a system administrator commands to be sent to each data source 305 that can be used to revoke any user's privileges on that data source 305, which privileges manager 370 or definition manager 310 stores into monitored information storage 306. Privileges manager 370 revokes such user's privileges, at one, more, or all of the data sources 305 using the user identifier and other information stored in monitored information storage 306 and the commands for each such data source when requested by the system administrator. In one embodiment, such revocation of a user's privileges is performed automatically according to the set of rules described below by privileges manager 370 for the data sources 305 corresponding to the highest monitored activity scores if the overall score or a period type score for a user is in a first range and none of the monitored behavior scores are above a threshold, or privileges manager 370 revokes privileges for all data sources 305 corresponding to the behaviors if the overall score or any period type score is in a second, higher range or one or more of the monitored behavior scores are above the threshold. The ranges and thresholds may be determined via conventional regression analysis techniques using historical data from known good and known bad users to keep false positives or false negatives within certain specified ranges.

All system elements may implement the features of the present invention. The system elements identified as storage may include memory or disk storage and may include a conventional database. Other system elements may be implemented as dedicated circuitry to perform the various functions described herein or may use a hardware processor running a stored computer program. Each system element may include a conventional hardware processor or hardware processor system or processor system or processor that is coupled to a hardware memory or hardware memory system or memory or memory system, each of these being conventional in nature. The processor is specially programmed to operate as described herein. All system elements are structural: the only nonce word to be used herein is “means”. Each system element described herein may include computer software or firmware running on a conventional computer system. Each system element labeled “storage” may include a conventional computer storage such as memory or disk and may include a conventional database. Each system element may contain one or more inputs, outputs and/or input/outputs to perform the functions described herein. Any system element may incorporate any of the features of the method and vice versa. System elements are coupled to one another to perform the functions described herein and may utilize data obtained in any possible manner.

### Certain Embodiments

Described is a method of monitoring activity of a secure computer system, the receiving definitions of two or more targets of each of two or more data sources, the targets including users or, and/or computer programs that interact with, at least one of the data sources;

receiving definitions for two or more behaviors, each behavior including at least one activity that is performed on at least one of the two or more data sources;

receiving definitions of two or more period types of special time periods for which the two or more behaviors during at least some of the special time periods are expected to have means that deviate from means of periods outside of the special time periods;

receiving from each of the two or more data sources indications of actions performed by the two or more targets using the two or more data sources within a specified period, an identifier of the one of the two or more the targets that performed each action, and the dates of said actions or specified period;

applying the definitions of the two or more behaviors to the indications of actions, for each of the two or more targets to identify two or more behaviors performed by each said target;

identifying at least one applicable period type for the specified period;

identifying a count for each of the two or more behaviors performed by each target during the specified period;

identifying at least one statistic including a mean number of times each behavior of the two or more behaviors performed by each said target was performed by said target in at least one period before the specified period, for each of the at least one applicable period types;

for each of the two or more behaviors performed by a target, applying a model to the at least one statistic for said behavior and said target and to a number of times said behavior was identified as performed by said target, to compute at least one behavior score for each of the applicable period types;

combining the at least one behavior score for each of the at least one applicable period type to compute a period type score for each applicable period type for each target;

computing for each target a total score using the period type score for each of the at least one applicable period type for each target; and

revoking a target's privileges on at least one of the two or more data sources responsive to the total score or at least one of the at least one period type score for said target being outside of a threshold.

The method may contain additional features, whereby at least one of the two or more targets comprises at least one computer program and at least one of the two or more targets comprises a user of at least one of the two or more data sources.

The method may contain additional features, whereby the at least one computer program comprises two or more computer programs, and the method additionally comprises receiving two or more identifiers of computer programs that are to be treated as being a single target.

The method may contain additional features, whereby the period type definitions correspond to a tax filing season.

The method may contain additional features, whereby the model for each behavior is one of two or more models that is selected based on a measure of independence of two or more activities of the behavior.

The method may contain additional features, whereby the independence is measured across two or more the two or more targets.

Described is a system for monitoring activity of a secure computer system, the method including:

a definition manager having an input for receiving definitions of two or more targets of each of two or more data sources, the targets including users or, and/or computer programs that interact with, at least one of the data sources, and for receiving definitions for two or more behaviors, each behavior including at least one activity that is performed on at least one of the two or more data sources, and for receiving definitions of two or more period types of special time periods for which the two or more behaviors during at least some of the special time periods are expected to have means that deviate from means of periods outside of the special time periods, the definition manager for providing at an output the definitions received at the input;

a retrieval manager having an input for receiving from each of the two or more data sources indications of actions performed by the two or more targets using the two or more data sources within a specified period, an identifier of the one of the two or more the targets that performed each action, and the dates of said actions or specified period, the retrieval manager for providing at an output the indications of actions, the identifiers of the one of the two or more targets that performed each action and the dates of the actions or specified period;

a normal activity manager having an input coupled to the retrieval manager output for receiving the indications of actions, the identifiers of the one of the two or more targets that performed each action and the dates of the actions or specified period and to the definition manager output for receiving the definitions, the normal activity manager for applying the definitions of the two or more behaviors to the indications of actions, for each of the two or more targets to identify two or more behaviors performed by each said target, and for identifying at least one applicable period type for the specified period, and for identifying a count for each of the two or more behaviors performed by each target during the specified period, and for identifying at least one statistic including a mean number of times each behavior of the two or more behaviors performed by each said target was performed by said target in at least one period before the specified period, for each of the at least one applicable period types, and for each of the two or more behaviors performed by a target, applying a model to the at least one statistic for each said behavior and each said target and to a number of times said behavior was identified as performed by said target, to compute at least one behavior score for each of the applicable period types for said, and for combining the at least one behavior score for each of the at least one applicable period type and target to compute a period type score for each applicable period type for each target, and for computing and providing at an output a total score using the period type score for each of the at least one applicable period type; and a privileges manager having an input coupled to the normal activity manager output for receiving the total score and revoking a target's privileges on at least one of the two or more data sources responsive to the total score outside of a threshold.

The system may contain additional features, whereby at least one of the two or more targets comprises at least one computer program and at least one of the two or more targets comprises a user of at least one of the two or more data sources.

The system may contain additional features, whereby:

the at least one computer program comprises two or more computer programs; and

the definition manager additionally receives definitions of two or more computer programs that are to be treated as being a single target.

The system may contain additional features, whereby the period type definitions correspond to a tax filing season.

The system:

may additionally include an independence/thresholds manager that selects the model for each behavior from two or more models that is selected based on a measure of independence of two or more activities of said behavior and provides at an output the an identifier of the selected model for each of the two or more behaviors; and

may contain additional features, whereby the normal activity manager input is coupled to the independence/thresholds manager output for receiving identifier of the model for each of the two or more behaviors, and the normal activity manager applies the model for each behavior responsive to the identifier received at the normal activity manager input.

The system may contain additional features, whereby the independence is measured across two or more the two or more targets.

Described is a computer program product including a computer useable medium having computer readable program code embodied therein for monitoring activity of a secure computer system, the computer program product including computer readable program code devices configured to cause a computer system to:

receive definitions of two or more targets of each of two or more data sources, the targets including users or, and/or computer programs that interact with, at least one of the data sources;

receive definitions for two or more behaviors, each behavior including at least one activity that is performed on at least one of the two or more data sources;

receive definitions of two or more period types of special time periods for which the two or more behaviors during at least some of the special time periods are expected to have means that deviate from means of periods outside of the special time periods;

receive from each of the two or more data sources indications of actions performed by the two or more targets using the two or more data sources within a specified period, an identifier of the one of the two or more the targets that performed each action, and the dates of said actions or specified period;

apply the definitions of the two or more behaviors to the indications of actions, for each of the two or more targets to identify two or more behaviors performed by each said target;

identify at least one applicable period type for the specified period;

identify a count for each of the two or more behaviors performed by each target during the specified period;

identify at least one statistic including a mean number of times each behavior of the two or more behaviors performed by each said target was performed by said target in at least one period before the specified period, for each of the at least one applicable period types;

for each of the two or more behaviors performed by a target, apply a model to the at least one statistic for said behavior and said target and to a number of times said behavior was identified as performed by said target, to compute at least one behavior score for each of the applicable period types;

combine the at least one behavior score for each of the at least one applicable period type to compute a period type score for each applicable period type for each target;

compute for each target a total score using the period type score for each of the at least one applicable period type for each target; and

revoke a target's privileges on at least one of the two or more data sources responsive to the total score or at least one of the at least one period type score for said target being outside of a threshold.

The computer program product may contain additional features, whereby at least one of the two or more targets comprises at least one computer program and at least one of the two or more targets comprises a user of at least one of the two or more data sources.

The computer program product may contain additional features, whereby the at least one computer program comprises two or more computer programs, and the computer program product additionally comprises computer readable program code devices configured to cause the computer system to receive two or more identifiers of computer programs that are to be treated as being a single target.

The computer program product may contain additional features, whereby the period type definitions correspond to a tax filing season.

The computer program product may contain additional features, whereby the model for each behavior is one of two or more models and the computer program product additionally comprises the computer readable program code devices configured to cause the computer system to select the model for the behavior based on a measure of independence of two or more activities of the behavior.

The computer program product may contain additional features, whereby the independence is measured across two or more the two or more targets.

Described is an apparatus for monitoring activity of a secure computer system, the apparatus including a processor configured for receiving definitions of two or more targets of each of two or more data sources, the targets including users or, and/or computer programs that interact with, at least one of the data sources, the processor additionally configured for receiving definitions for two or more behaviors, each behavior including at least one activity that is performed on at least one of the two or more data sources, the processor additionally configured for receiving definitions of two or more period types of special time periods for which the two or more behaviors during at least some of the special time periods are expected to have means that deviate from means of periods outside of the special time periods, the processor additionally configured for receiving from each of the two or more data sources indications of actions performed by the two or more targets using the two or more data sources within a specified period, an identifier of the one of the two or more the targets that performed each action, and the dates of said actions or specified period, the processor additionally configured for applying the definitions of the two or more behaviors to the indications of actions, for each of the two or more targets to identify two or more behaviors performed by each said target, the processor additionally configured for identifying at least one applicable period type for the specified period, the processor additionally configured for identifying a count for each of the two or more behaviors performed by each target during the specified period, the processor additionally configured for identifying at least one statistic including a mean number of times each behavior of the two or more behaviors performed by each said target was performed by said target in at least one period before the specified period, for each of the at least one applicable period types, the processor additionally configured for each of the two or more behaviors performed by a target, applying a model to the at least one statistic for said behavior and said target and to a number of times said behavior was identified as performed by said target, to compute at least one behavior score for each of the applicable period types, the processor additionally configured for combining the at least one behavior score for each of the at least one applicable period type to compute a period type score for each applicable period type for each target, the processor additionally configured for computing for each target a total score using the period type score for each of the at least one applicable period type for each target, and, the processor additionally configured for revoking a target's privileges on at least one of the two or more data sources responsive to the total score or at least one of the at least one period type score for said target being outside of a threshold.

The apparatus may contain additional features, whereby at least one of the two or more targets comprises at least one computer program and at least one of the two or more targets comprises a user of at least one of the two or more data sources.

The apparatus may contain additional features, whereby the at least one computer program comprises two or more computer programs, and the, the processor is additionally configured for receiving two or more identifiers of computer programs that are to be treated as being a single target.

The apparatus may contain additional features, whereby the period type definitions correspond to a tax filing season.

The apparatus may contain additional features, whereby the model for each behavior is one of two or more models that is selected by the processor based on a measure of independence of two or more activities of the behavior. The apparatus may contain additional features, whereby the independence is measured across two or more the two or more targets.

What is claimed is:

1. An apparatus for monitoring activity of a secure computer system, the apparatus, comprising
at least one memory configured to store instructions; and
at least one processor configured to execute the instructions and cause the apparatus to perform,
receiving definitions of a plurality of targets of each of a plurality of data sources, the targets comprising users of or computer system elements that interact with, at least one of the data sources,
receiving definitions of a plurality of behaviors, each behavior in the plurality of behaviors comprising at least one activity that is performed on at least one of the plurality of data sources,
receiving definitions of a plurality of period types of special time periods for which the plurality of behaviors during at least some of the special time periods are expected to have means that deviate from means of periods outside of the special time periods,
receiving, from each of the plurality of data sources, indications of actions performed by the plurality of targets using the plurality of data sources within a specified period, an identifier of the plurality of the targets that performed each of the actions, and dates of the specified period,
applying the definitions of the plurality of behaviors to the indications of actions, for each of the plurality of targets, to identify a plurality of behaviors performed by each of the plurality of targets,
identifying at least one applicable period type of the plurality of period types for the specified period,
identifying a count for each of the plurality of behaviors performed by each of the plurality of targets during the specified period,
determining at least one statistic including a mean number of times each behavior of the plurality of behaviors performed by each of the plurality of targets was performed by said target in at least one period before the specified period for each of the at least one applicable period type,
determining at least one behavior score for each of the plurality of behaviors performed by each of the plurality of targets for each of the at least one applicable period type by applying a model to the at least one statistic for said behavior and said target and to a number of times said behavior was identified as performed by said target,
determining a period type score for each of the targets for each of the at least one applicable period type based on the at least one behavior score for each of the at least one applicable period,
determining a total score for each of the targets based on the period type score for each of the at least one applicable period type for each target, and
automatically revoking a target's privileges on at least one of the plurality of data sources by automatically retrieving identification information of a target from a database and sending the identification information and a revocation instruction to the at least one of the plurality of data sources responsive to the total score or at least one of the at least one period type score for said target being outside of a threshold indicating anomalous behavior of the target.

2. The apparatus of claim 1, wherein the at least one computer system element comprises a plurality of computer system elements and the at least one processor is further configured to execute the instructions and cause the apparatus to perform receiving a plurality of identifiers of each of at least some of the plurality of computer system elements that are to be treated as being a single target.

3. The apparatus of claim 1, wherein the definitions of the plurality of period types correspond to a tax filing season.

4. The apparatus of claim 1, wherein the model for each behavior is one of a plurality of models that is selected by the at least one processor based on a measure of independence of a plurality of activities of the behavior.

5. The apparatus of claim 4, wherein the independence is measured across a plurality of the plurality of targets.

6. A method for monitoring activity of a secure computer system, the method comprising:
receiving definitions of a plurality of targets of each of a plurality of data sources, the targets comprising users of or computer system elements that interact with, at least one of the data sources,
receiving definitions of a plurality of behaviors, each behavior in the plurality of behaviors comprising at least one activity that is performed on at least one of the plurality of data sources,
receiving definitions of a plurality of period types of special time periods for which the plurality of behaviors during at least some of the special time periods are expected to have means that deviate from means of periods outside of the special time periods,
receiving, from each of the plurality of data sources, indications of actions performed by the plurality of targets using the plurality of data sources within a specified period, an identifier of the plurality of the targets that performed each of the actions, and dates of the specified period,
applying the definitions of the plurality of behaviors to the indications of actions, for each of the plurality of targets, to identify a plurality of behaviors performed by each of the plurality of targets,
identifying at least one applicable period type of the plurality of period types for the specified period,
identifying a count for each of the plurality of behaviors performed by each of the plurality of targets during the specified period,
determining at least one statistic including a mean number of times each behavior of the plurality of behaviors performed by each of the plurality of targets was performed by said target in at least one period before the specified period for each of the at least one applicable period type,
determining at least one behavior score for each of the plurality of behaviors performed by each of the plurality of targets for each of the at least one applicable period type by applying a model to the at least one statistic for said behavior and said target and to a number of times said behavior was identified as performed by said target,
determining a period type score for each of the targets for each of the at least one applicable period type based on the at least one behavior score for each of the at least one applicable period,
determining a total score for each of the targets based on the period type score for each of the at least one applicable period type for each target, and
automatically revoking a target's privileges on at least one of the plurality of data sources by automatically retrieving identification information of a target from a database and sending the identification information and a revocation instruction to the at least one of the plurality of data sources responsive to the total score or at least one of the at least one period type score for said target being outside of a threshold indicating anomalous behavior of the target.

7. The method of claim 6, wherein the at least one computer system element comprises a plurality of computer system elements and the method further includes receiving a plurality of identifiers of each of at least some of the plurality of computer system elements that are to be treated as being a single target.

8. The method of claim 6, wherein the definitions of the plurality of period types correspond to a tax filing season.

9. The method of claim 6, wherein the model for each behavior is one of a plurality of models that is selected based on a measure of independence of a plurality of activities of the behavior.

10. The method of claim 9, wherein the independence is measured across a plurality of the plurality of targets.
